(19) United States
(12) Patent Application Publication
(10) Pub. No.: US 2020/0372538 A1
(43) Pub. Date: Nov. 26, 2020

(54) PRIORITIZED LEADERS FOR DISTRIBUTING CONTENT

(71) Applicant: International Business Machines Corporation, Armonk, NY (US)

(72) Inventors: Jeremy R. Fox, Georgetown, TX (US); Liam S. Harpur, Dublin (IE); Christian B. Kau, Mountain View, CA (US); John C. Rice, West Pennant Hills (AU)

(21) Appl. No.: 16/421,296

(22) Filed: May 23, 2019

(51) Int. Cl. G06Q 30/02; G06Q 50/00

(52) U.S. Cl. CPC G06Q 30/0254; G06F 9/455; G06Q 50/01

(57) ABSTRACT

A computer-implemented method includes analyzing content associated with a plurality of users, selecting a group of users associated with a topic of the content and generating a class model for the group of users based on the analysis. The computer-implemented method also includes providing new content to the group of users and identifying a leader of the group of users based on relationships defined by the class model and the new content. The computer-implemented method also includes providing a notification to the leader, wherein the notification encourages the leader to engage with the new content.

### BACKGROUND

The present invention relates to class modeling, and more particularly, this invention relates to class modeling for content distribution in cloud storage systems and networks.

### SUMMARY

A computer-implemented method, according to one embodiment, includes analyzing content associated with a plurality of users, selecting a group of users associated with a topic of the content and generating a class model for the group of users based on the analysis. The computer-implemented method also includes providing new content to the group of users and identifying a leader of the group of users based on relationships defined by the class model and the new content. The computer-implemented method also includes providing a notification to the leader, wherein the notification encourages the leader to engage with the new content.

A system, according to one embodiment, includes a processor and logic integrated with the processor, executable by the processor, or integrated with and executable by the processor. The logic is configured to perform the foregoing method.

A computer program product for distributing content, according to one embodiment, includes a computer readable storage medium having program instructions embodied therewith. The program instructions are executable by a computer to cause the computer to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one embodiment of the present invention.

FIG. 2 depicts abstraction model layers in accordance with one embodiment of the present invention.

FIG. 3 is a high-level architecture for performing various operations of FIG. 4, in accordance with one embodiment of the present invention.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of assimilating content for a following group.

In one general embodiment, a computer-implemented method includes analyzing content associated with a plurality of users, selecting a group of users associated with a topic of the content and generating a class model for the group of users based on the analysis. The computer-implemented method also includes providing new content to the group of users and identifying a leader of the group of users based on relationships defined by the class model and the new content. The computer-implemented method also includes providing a notification to the leader, wherein the notification encourages the leader to engage with the new content.

In another general embodiment, a system includes a processor and logic integrated with the processor, executable by the processor, or integrated with and executable by the processor. The logic is configured to perform the foregoing method.

In yet another general embodiment, a computer program product for distributing content includes a computer readable storage medium having program instructions embodied therewith. The program instructions are executable by a computer to cause the computer to perform the foregoing method.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

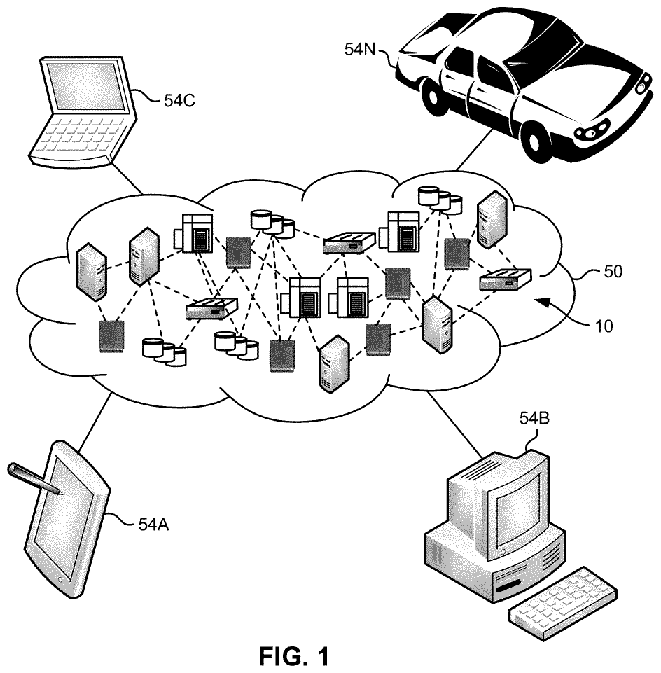

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

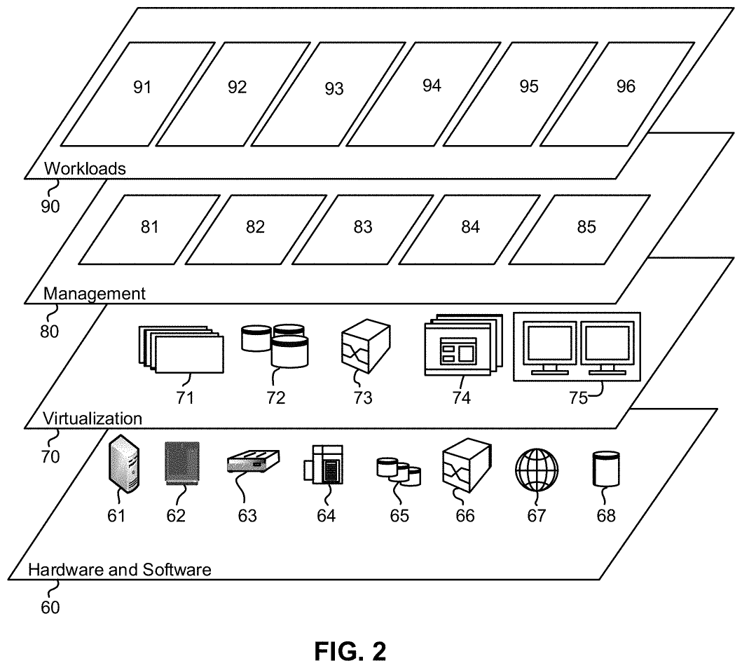

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and content distribution 96.

Class modeling generally refers to a type of static structure diagram that describes classes of a system including interrelationships between the classes, operations of the classes, attributes of the classes, etc. Class modeling has a variety of applications including general conceptual application modeling, detail modeling for translation into programming code, data modeling, etc.

Content distribution covers a variety of marketing tactics which promote and/or distribute content to targeted audiences in multiple media formats through various channels. Many strategies exist for promoting and/or distributing content with varying levels of success. A continuing goal for content distribution is to efficiently use resources to obtain the farthest reach for content.

Content distribution conventionally involves targeting users who are likely to engage with the content. Promoting new content in online formats may increase the likelihood that the content will reach target users, especially in online forums where users may express and share opinions with other users. In various marketing approaches, target users may be identified through market research as being capable of influencing a larger group of users to engage with certain content. In conventional applications of such market research, target users are not actively encouraged to engage in certain content. Rather, conventional marketing techniques aim various advertising messages toward target users. Aimed marketing is not always effective for promoting new content, especially when the content is not a product for purchase.

In stark contrast, various embodiments of the present disclosure enhance content distribution by identifying specific target users as “leaders” of the community (e.g., senior members, key influencers, subject matter experts, etc.) and encouraging those leaders to promote and/or assimilate content to the community (e.g., the following group). Various embodiments capture information relating to leaders to determine a probability that the leader will engage with the content (e.g., promote and/or assimilate the content to the community) and that such engagement will influence others in the community to similarly engage with the content. At least some of the disclosed embodiments leverage the expertise of the leader to improve the group's efficiency and/or development of future interactions.

In preferred embodiments, the leader is identified and encouraged to engage with new content based on the context, topic, group, etc., of the new content and/or the type and/or level of leadership associated with the leader. The leader may be dynamically updated based on changes in topic so that different users may have the opportunity to take over the leader position based on the user's expertise, skill level, interests, role in the community, etc., among other factors.

It should be understood by one having ordinary skill in the art upon reading this disclosure that various operations of the present invention may be performed only with a user's permission. Various embodiments may be opt-in applications. Information about users is gathered with the user's consent.

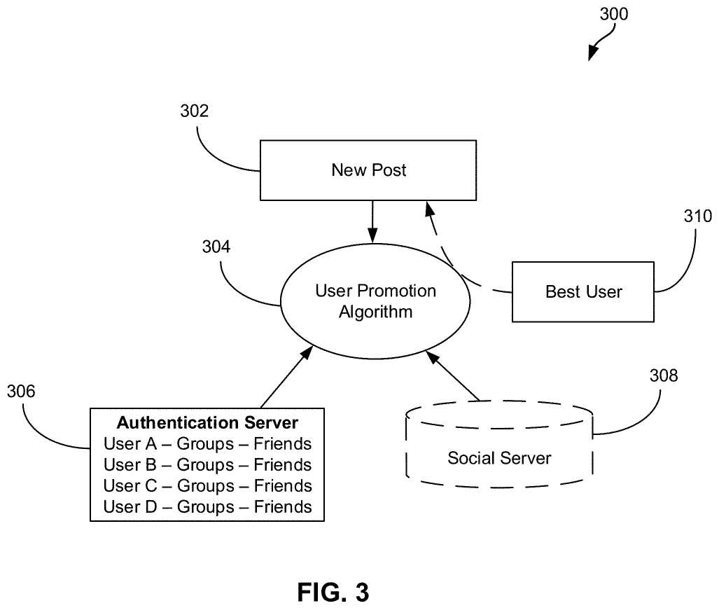

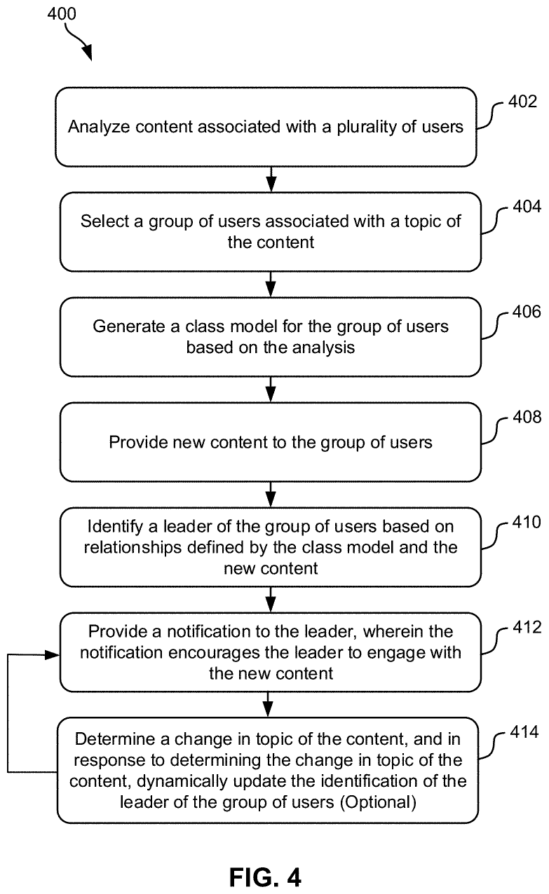

FIG. 3 is a high-level architecture for performing various operations of FIG. 4, in accordance with various embodiments. The architecture 300 may be implemented in accordance with the present invention in any of the environments depicted in FIGS. 1-2 and 4, among others, in various embodiments. Of course, more or less elements than those specifically described in FIG. 3 may be included in architecture 300, as would be understood by one of skill in the art upon reading the present descriptions.

Each of the steps of the method 400 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 400 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 comprises a new post 302. The new post 302 may be generated by a user, a service provider, a content provider, etc., or any combination of the foregoing entities. The new post 302 may be interchangeably referred to herein as new content. The new post 302 may comprise any combination of visual media, audio media, textual media, audiovisual media, or any other types of media known in the art. The new post 302 may be directed to the user promotion algorithm 304. The new post 302 may be directed to the user promotion algorithm 304 in any manner known in the art. Any topic analysis technique may be used to determine at least one topic associated with the new post 302.

The user promotion algorithm 304 may use any class modeling technique known in the art to determine the leader (e.g., the best user 310) who is most likely to promote and/or assimilate the new post 302 to the community based on the topic of the new post 302. A leader may be a senior member of a group of users, a key influencer, a creator of high quality content, a user who frequently engages with content generated by a plurality of users, a subject matter expert, a manager and/or relatively higher position (e.g., in terms of employment, club hierarchy, etc.) in a group of users, etc., as derived from the class model and/or the topic of the new post 302.

Any inputs for the user promotion algorithm 304 are gathered with a user's permission. Inputs for the user promotion algorithm 304 may include information derived from an authentication server 306 including user relationships, hierarchy on the topic of the post, reach of the user and/or content associated with the user, online activity statistics, etc. Further information may be derived from a collaboration server 308 for inputs for the user promotion algorithm 304. Information derived from a collaboration server 308 may comprise information associated with social media applications, user relationships, content of online activity including posts, likes, interests, pins, etc. Additional input information may be derived from other sources including manual input by the user, theoretical information derived by market research, etc.

The user promotion algorithm 304 may output the best user 310 in any manner known in the art. The best user 310 may be encouraged to promote and/or assimilate content according to the various operations of method 400 as described in detail below.

Now referring to FIG. 4, a flowchart of a method 400 is shown according to one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

In various embodiments of method 400, the plurality of users and/or the group of users are associated with respect to a forum including any type of electronic platform, e.g., a network, a website, a message thread, that one or more users may access. In one configuration, method 400 may be implemented with and/or as an opt-in application, e.g., such as an application where users post content and/or engage with content.

As shown in FIG. 4, method 400 includes operation 402. Operation 402 includes analyzing content associated with a plurality of users. Content associated with a plurality of users may be gathered and/or analyzed with a user's permission. Content may be generated on an ongoing basis by the one or more users. Content may include user relationships, hierarchy in relationship to a topic (e.g., a manager in an architecture design group), reach of users and/or posts associated with users, online activity statistics, etc. Content may comprise information associated with social media applications including content of online activity including posts, likes, interests, pins, articles, comments, likes, reshares, retweets, discussions, etc. Content may be manually input by users, theoretical information derived by market research, etc.

In various approaches, analyzing content associated with a plurality of users includes identifying at least one topic within the content. The content associated with a plurality of users may comprises a plurality of topics. For example, a plurality of users may generate content within a forum for “Bird Watching.” Within the content, topics may include “Bird Watching In San Jose,” “California Clapper Rail,” etc. In a preferred approach, a topic of the content may be determined using any topic analysis techniques known in the art.

In other approaches, analyzing content associated with a plurality of users includes identifying a context of the content. For example, the context may include the time, date, user, location, etc., associated with the content.

Operation 404 includes selecting a group of users associated with a topic of the content. The group of users associated with a topic of the content may be selected in any manner known in the art. In various approaches, the plurality of users may comprise subgroups of users which are associated with at least one topic. For example, the group of users who engage specifically with content associated with Bird Watching in the Bay Area may be selected for a group of users (e.g., for example, “California Clapper Rail Enthusiasts,” “Endangered Species Bird Watchers,” etc.). In a preferred approach, operation 404 selects each group of users based on common topics, interests, content, etc.

Operation 406 includes generating a class model for the group of users based on the analysis. Generating a class model may include any class modeling and/or statistical analysis technique known in the art. In a preferred approach, operation 406 generates a class model for each group based on common topics, interests, content, etc. In another preferred approach, the class model identifies the key interrelationships between the users, attributes of the users, level of influence of each user (e.g., potential reach of the user), the types of leadership, the levels of leadership, etc.

In a preferred approach, the class model includes the type and/or level of class model leadership for each user. A type of leadership may refer to transformational leadership, transactional leadership, servant leadership, autocratic leadership, laissez-faire leadership, democratic leadership, bureaucratic leadership, charismatic leadership, situational leadership, etc. A level of leadership may refer to position, permission, production, people development, pinnacle, a highly capable individual, a contributing team member, a competent manager, an effective leader, an executive, etc. In some approaches, a class model may be used to determine the type and/or level of leadership which is best to promote and/or assimilate new content to the community of users.

Various class modeling processing as described herein may use techniques known in the art. In one approach, the class modeling and/or analysis of the content associated with the group of users may be based on natural language processing techniques known in the art. Any known technique may be used to perform natural language processing including Google Cloud® Natural Language, Natural Language Toolkit, Apache Lucene™, Apache Solr™, Apache OpenNLP™, CoreNLP™, SpaCy®, etc. In a preferred embodiment, the natural language processing is performed using Watson™ Natural Language Understanding, Watson™ Tone Analyzer, and/or Watson™ Natural Language Classifier (International Business Machines Corporation (IBM), 1 New Orchard Road, Armonk, New York 10504, United States).

In some approaches, content associated with the group of users may include information associated with each user including length of overall activity in the group of users, length of individual periods of activity in the group of users, number of comments and/or shares within the group of users, etc. In other approaches, content associated with each user which is relevant to a level of influence associated with a user includes user current employment, past employment, management experience, the size of the user's employment team, etc.

Operation 408 includes providing new content to the group of users. The new content may be provided to the group of users, to the user identified in operation 410 as the leader, to a subset of the group of users, etc. The new content may be generated by one or more users within the group of users, a content provider, a service provider, a manufacturer, etc.

Operation 410 includes identifying a leader for the group of users based on the relationships defined by the class model and the new content. Potential leaders within the group of users may be analyzed for appropriateness to “lead” the group of users (e.g., the following group). A leader may be identified by a propensity to post, a likelihood to respond to a request to be a leader, a likelihood of influence on the group of users, the type of leadership, the level of leadership, etc. Any combination of the foregoing factors may be used to select a leader from the group of users. The foregoing factors may be derived from the class model and/or statistical analysis techniques known in the art. In a preferred approach, the leader is identified based on the type and/or level of leadership in relation to the topic of the new content.

Operation 412 includes providing a notification to the leader wherein the notification encourages the leader to engage with the new content. The notification may be output to the user in any manner known in the art. In a preferred approach, the notification includes a request that the identified leader accept the role as the leader. The notification preferably informs the leader of the status of the leader.

In one approach, the notification includes a recommendation to share the new content. Operation 412 may encourage the identified leader of the group to share the new content and/or reshare the new content in the case where the content is already available to the group of users. In another approach, the notification includes a recommendation to comment on the new content. For example, an identified leader may be encouraged to comment on new content so that other users see the benefit of the new content.

In an alternative embodiment, the notification includes a recommended comment on the new content. A recommended comment may be generated by the content provider, the service provider, a manufacturer of a product disclosed in the new content, generic comments, etc.

In various embodiments, an action by the identified leader includes a comment, share, reshare, favorite, like, pin, etc.

In one example, a notification may include, “You are the first user from your Java performance group that has visited this page and you have been identified as a leader for your group. Do you accept this role as the leader? Would you like to comment and/or reshare this page to help members of your group who may visit this page?”

In another approach, in response to a lack of acceptance and/or action from the identified leader, the method 400 may resend the notification after a predetermined period of time. The predetermined period of time may be set by the user, a content provider, a service provider, etc. In another approach, in response to a lack of acceptance and/or action from the identified leader, operation 410 may include identifying another user as the leader for the group of users based on the factors described above.

In one embodiment, in response to the identified leader accepting the role as leader and/or performing an action, the group of users may be notified of the new content and/or the identified leader's interaction with the new content.

Operation 414 may include, determining a change in topic of the content generated by the group of users, and in response to determining a change in topic of content, dynamically updating the identification of the leader within the group of users. In various embodiments, the content generated by and/or associated with the group of users is monitored and/or analyzed on a substantially continuous basis. Alternatively, the content of the group of users may be analyzed sporadically, periodically based on a predefined period of time set by the user, the content provider, a service provider, etc. In a preferred embodiment, the topic of the content is analyzed. The topic of the content may be analyzed using various techniques known in the art. A new leader may be identified based on characteristics associated with the new topic derived from the class model as discussed above.

In a preferred approach, updating the identification of the leader within the group of users includes providing a notification to the new leader. The notification may comprise any of the embodiments described above.

The method 400 may iterate between operations 412 and operation 414 for any predefined period of time. In one embodiment, the identification of leaders and/or other information derived from the content of the group of users may be mapped and/or trended over time using any technique known in the art. Users within the group may be able to adapt behavior and/or content based on the mapping in order to increase the likelihood of being chosen as a leader.

In one example of the foregoing method, a group of users may be identified as a Java club based on class modeling of the content generated by a plurality of users. The method may identify userA as a leader that other users in the group are likely to follow. In the present example, userA may be a senior member of the Java club. The method proactively notifies userA of the identification and requests that userA review and comment on new content available to the group of users such that the group of users may be encouraged to similarly engage with the content. For example, if userA is the first from the Java club to view images of the new Java test tools on webpageB, the method may provide a notification to userA requesting that userA post a comment with the aim of promoting and/or assimilating the new content within the Java club. Others within the group may not otherwise be aware of the new content and/or not appreciate the value of the new content without the influence of the identified leader.

Various embodiments disclosed herein enhance the user experience by encouraging engagement with content that may otherwise go unnoticed and/or unacknowledged.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing content associated with a plurality of users;
selecting a group of users associated with a topic of the content;
generating a class model for the group of users based on the analysis;
providing new content to the group of users;
identifying a leader of the group of users based on relationships defined by the class model and the new content; and
providing a notification to the leader, wherein the notification encourages the leader to engage with the new content.

2. The computer-implemented method of claim 1, comprising: determining a change in topic of the content; and in response to determining the change in topic of the content, dynamically updating the identification of the leader of the group of users.

3. The computer-implemented method of claim 2, wherein updating the identification of the leader of the group of users includes providing a notification to the new leader.

4. The computer-implemented method of claim 1, wherein the class model includes a type and/or level of leadership for each user.

5. The computer-implemented method of claim 1, wherein the notification to the leader includes a recommendation to share the new content.

6. The computer-implemented method of claim 1, wherein the notification to the leader includes a recommendation to comment on the new content.

7. The computer-implemented method of claim 1, wherein the notification to the leader informs the leader of the status of the leader.

8. The computer-implemented method of claim 1, wherein the notification to the leader includes a recommended comment on the new content.

9. The computer-implemented method of claim 1, wherein analyzing content associated with the plurality of users includes analyzing a context of the content.

10. A system, comprising:
a processor; and
logic integrated with the processor, executable by the processor, or integrated with and executable by the processor, the logic being configured to:
analyze content associated with a plurality of users;
select a group of users associated with a topic of the content;
generate a class model for the group of users based on the analysis;
provide new content to the group of users;
identify a leader of the group of users based on relationships defined by the class model and the new content; and
provide a notification to the leader, wherein the notification encourages the leader to engage with the new content.

11. The system of claim 10, comprising logic configured to: determine a change in topic of the content; and in response to determining the change in topic of the content, dynamically update the identification of the leader of the group of users.

12. The system of claim 11, wherein updating the identification of the leader of the group of users includes providing a notification to the new leader.

13. The system of claim 10, wherein the class model includes a type and/or level of class model leadership for each user.

14. The system of claim 10, wherein the notification to the leader includes a recommendation to share the new content.

15. The system of claim 10, wherein the notification to the leader includes a recommendation to comment on the new content.

16. The system of claim 10, wherein the notification to the leader informs the leader of the status of the leader.

17. A computer program product for distributing content, the computer program product comprising a computer readable storage medium having program instructions embodied therewith, the program instructions executable by a computer to cause the computer to:
analyze, by the computer, content associated with a plurality of users;
select, by the computer, a group of users associated with a topic of the content;
generate, by the computer, a class model for the group of users based on the analysis;
provide, by the computer, new content to the group of users;
identify, by the computer, a leader of the group of users based on relationships defined by the class model and the new content; and
provide, by the computer, a notification to the leader, wherein the notification encourages the leader to engage with the new content.

18. The computer program product of claim 17, comprising program instructions to cause the computer to: determine, by the computer, a change in topic of the content; and in response to determining the change in topic of the content, dynamically update, by the computer, the identification of the leader of the group of users.

19. The computer program product of claim 18, wherein updating the identification of the leader of the group of users includes providing a notification to the new leader.

20. The computer program product of claim 18, wherein the class model includes a type and/or level of class model leadership for each user.
